(19) United States
(12) Patent Application Publication
(10) Pub. No.: US 2024/0203016 A1
(43) Pub. Date: Jun. 20, 2024

(54) AUTOMATED HUMAN MESH AND SKELETON GENERATION AND ANIMATION APPARATUS, SYSTEM, AND METHOD

(71) Applicant: Groove Jones, LLC, Dallas, TX (US)

(72) Inventor: Dale Andrew Carman, Plano, TX (US)

(73) Assignee: Groove Jones, LLC, Dallas, TX (US)

(21) Appl. No.: 18/510,891

(22) Filed: Nov. 16, 2023

Related U.S. Application Data
(60) Provisional application No. 63/433,249, filed on Dec. 16, 2022.

(51) Int. Cl. G06T 13/40; G06K 7/14; G06T 17/20; H04N 23/90

(52) U.S. Cl. CPC G06T 13/40; G06K 7/1417; G06T 17/20; H04N 23/90; G06T 2210/32

(57) ABSTRACT

An apparatus, system and method designed, configured, and constructed to allow a user to create a high quality, digital 3-D model of a user including an armature or skeleton to articulate the limbs, torso, and body and delivering a shareable item in the form of a model for augmented reality, an animation delivered via mp4, or a real-time user controllable game model and further then delivering a link to the shareable item through text or email.

### CROSS-REFERENCE TO RELATED APPLICATIONS

This application claims the benefit of U.S. Provisional Application No. 63/433,249 filed Dec. 16, 2022, which is incorporated by reference herein in its entirety for any purpose.

### BACKGROUND OF THE INVENTION

### 1. Field of the Invention

This invention relates to a system, apparatus, and procedure for generating a human mesh and skeleton for character animation. More specifically, the present invention provides for automating the generation of a high quality robust animated skeleton from mesh without substantial effort, cost, time or need for tweaking to create satisfactory character animations.

### 2. Description of Related Art

Animation of 3-D objects is one of the most captivating parts of computer graphics. The realistic creation of 3-D animation of the human character has become a very popular and challenging task in movies, computer games, simulations, forensic animation, education, training, medical applications, surveillance systems and avatar animation. In character animation, the use of skeleton has an extensive role. The skeleton of a human character is a simplified version of geometry and topology of models, which facilitates shape manipulation and understanding. There are various applications of skeleton in computer graphics such as character rigging through skeleton embedding, mesh skinning using skeleton, and skeleton-driven soft body animation. Due to its versatility, skeleton-based animation has become the de facto standard for animating characters.

Generally, the skeleton has been made by using various commercial animation software. This software often requires manual tweaking of the skeleton. In most animation systems, representation of the 3-D object and its skeleton are disjointed, which often causes problems in animation of the objects. The skeleton animation and skeleton-based character animation still require experienced work and time-consuming processes.

To address these issues, the current disclosure presents a framework to generate an animated skeleton from human mesh automatically and optimize the entire process, making it possible to receive a high quality, animated scan within minutes, instead of days or months. The present disclosure provides for a system, apparatus, and method for creating a high quality, digital 3-D model of a user including an armature or skeleton to articulate the limbs, torso, and body and delivering a shareable item in the form of a model for augmented reality, an animation delivered via mp4, or a real-time user controllable game model and delivering a link to the shareable item through text or email.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

Embodiments of the present invention generally relate to a system, apparatus, and method for creating a high quality, digital 3-D model of a user including an armature or skeleton to articulate the limbs, torso, and body and delivering a shareable item in the form of a model for augmented reality, an animation delivered via mp4, or a real-time user controllable game model and delivering a link to the shareable item through text or email. It is understood to one skilled in the art that the present invention is not limited to any particular field of use and can be utilized as desired.

The basic inventive concept is to provide a system, apparatus, and method for creating a 3-D model of a person through adding a skeleton to make a scanned character that is not expensive, time-consuming, and laborious all without the need for specialized technicians and/or artists. In addition, the current method provides for a 3-D model that is not very dense and does not comprise a large mesh. The present apparatus, system and method automates and optimizes the entire process, making it possible to receive a high quality, animated scan within minutes, instead of days or months.

Objects of the invention not understood from the above, will be fully understood upon the review of the drawings and the description of the preferred embodiments which follow. Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any aspect of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

A more complete understanding of embodiments of the present invention may be obtained by reference to the following Detailed Description when taken in conjunction with the accompanying Drawings wherein:

FIG. 1A illustrates an overhead top view of the hardware of the present disclosure according to an embodiment of the present disclosure.

FIG. 1B illustrates a partial view of a portion of hardware including a tablet, side lighting and voids for accommodation of phone devices according to an embodiment of the present disclosure.

FIG. 1C illustrates a portion of hardware for attachment having horizontal and vertical axis adjustment and a light blocking apparatus according to an embodiment of the present disclosure.

FIG. 1D illustrates a back side portion of the hardware of the present disclosure according to an embodiment of the present disclosure.

FIG. 1E illustrates the scanner steps overview according to one embodiment of the present disclosure.

FIG. 2 illustrates the user registration step 101 as shown in FIG. 1E according to an embodiment of the present disclosure.

FIG. 3 illustrates the user scan step 102 as shown in FIG. 1E according to an embodiment of the present disclosure.

FIG. 4A illustrates further the model creation step 103 as shown in FIGS. 1E and 3 according to an embodiment of the present disclosure.

FIG. 4B illustrates the mesh production step of the model creation step 103 as shown in FIGS. 1E and 3 according to an embodiment of the present disclosure.

FIG. 5 illustrates the mesh cleanup step 275 of the model creation step 103 as shown in FIGS. 1E and 3 according to an embodiment of the present disclosure.

FIG. 6 illustrates the retarget animation step of the model creation step 103 as shown in FIGS. 1E and 3 according to an embodiment of the present disclosure.

FIG. 7 illustrates the shareable creation step 104 as shown in FIG. 1E according to an embodiment of the present disclosure.

FIG. 8 illustrates the user store 106 as shown in FIG. 1E according to an embodiment of the present disclosure.

FIG. 9 illustrates the shareable delivery step 105 as shown in FIG. 1E according to an embodiment of the present disclosure.

### DETAILED DESCRIPTION OF THE INVENTION

In the following description, numerous specific details are set forth to provide a thorough understanding of the present invention. However, it will be apparent to those skilled in the art that the present disclosure may be practiced without such specific details. It is to be understood that both the foregoing general summary description and the following detailed description are illustrative and explanatory, and are not restrictive of the subject matter, as claimed. It is to be further understood that the following disclosure also provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise. In addition, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “side,” “top,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

As may be used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The section headings used herein are for organizational purposes and are not to be construed as limiting the subject matter described. If any documents, or portions of documents, are cited in this application, including, but not limited to, patents, patent applications, articles, books, and treatises, such documents are hereby expressly incorporated herein by reference in their entirety for any purpose. In the event that one or more of such incorporated documents etc. and similar materials (if any) defines a term in a manner that contradicts the definition of that term in this application, this application controls.

During the discussion of the structural features of this invention, all references to the automated human mesh and skeleton generation and animation apparatus, and the like should be considered in their broadest aspect.

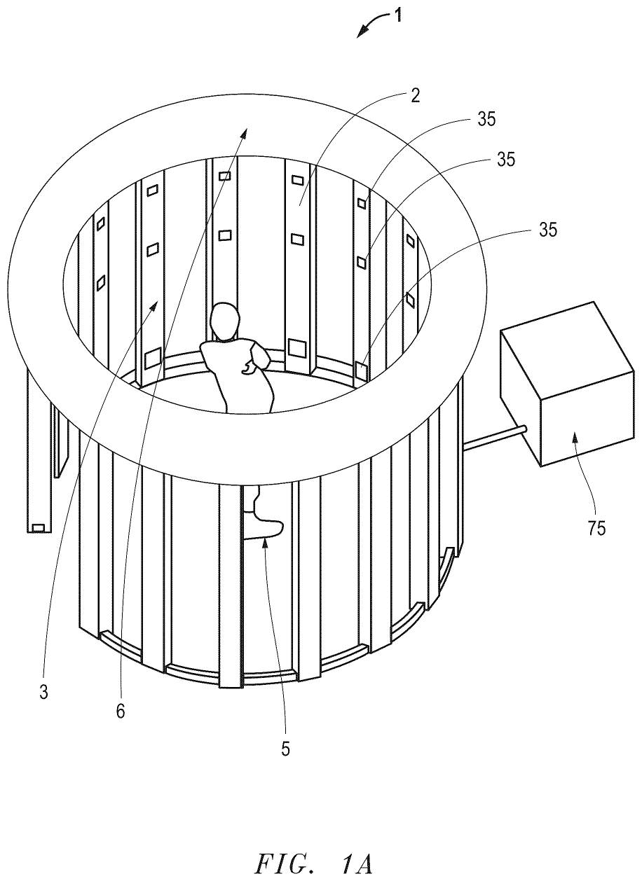

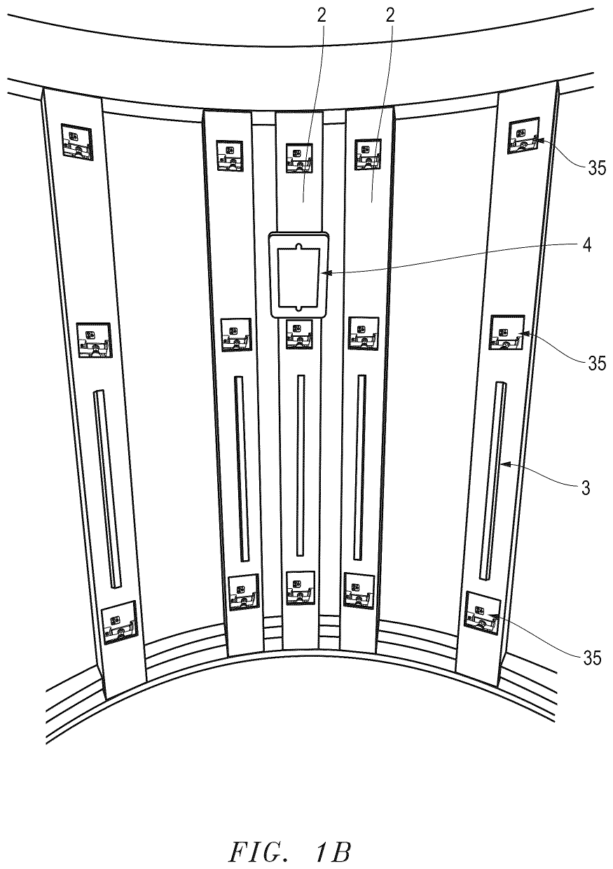

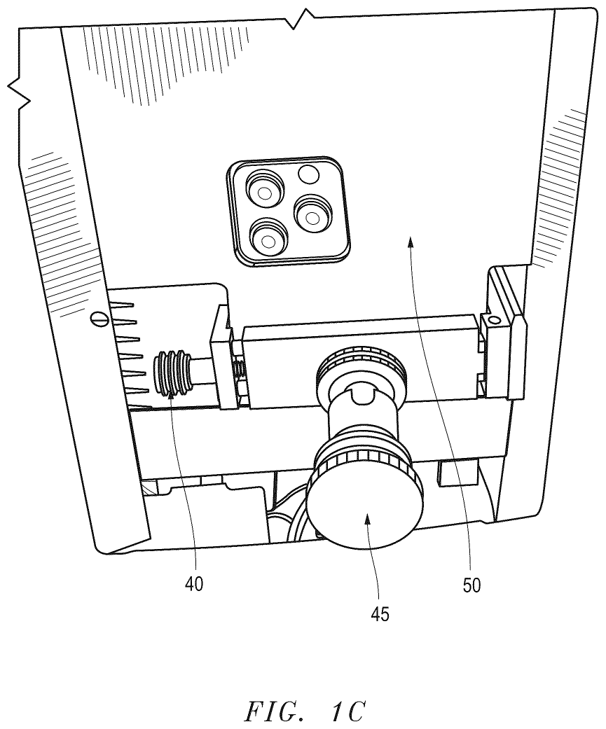

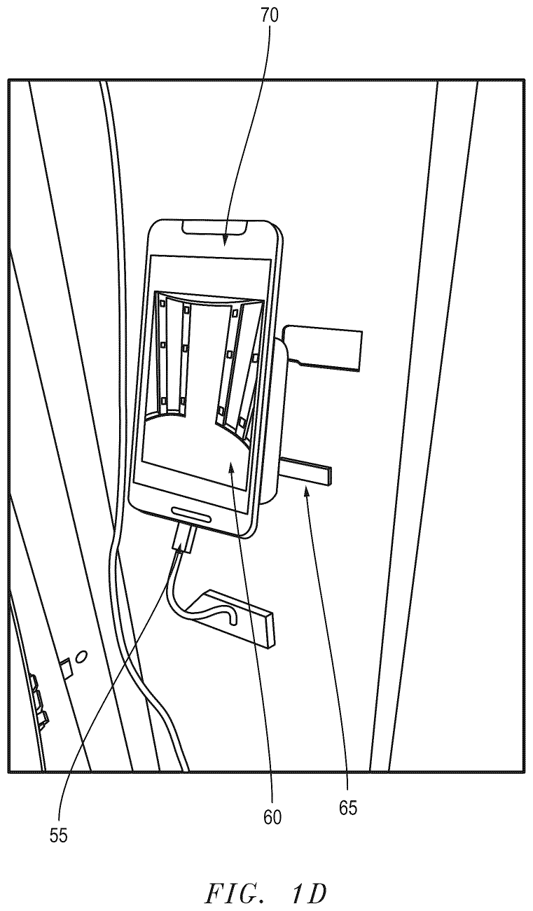

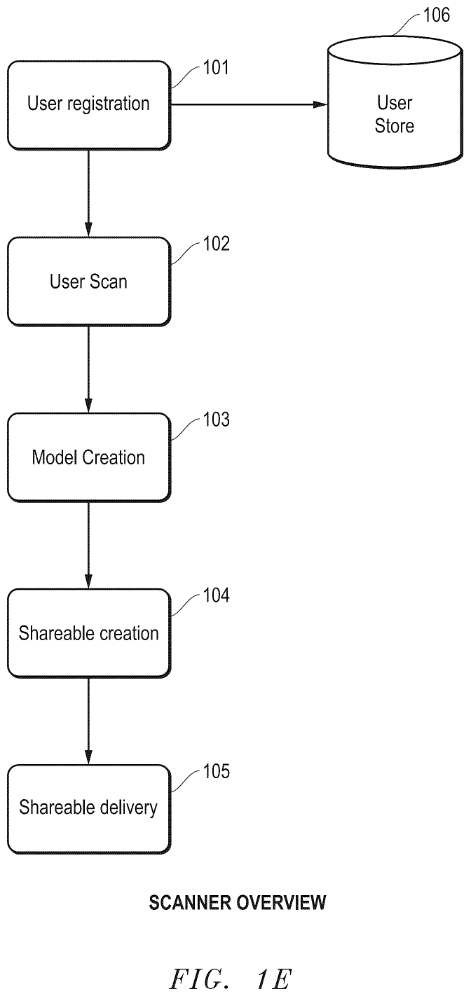

FIGS. 1A-1E provide for a general concept overview of a scanner 1 apparatus, system, and method in accordance with the present disclosure. Generally, the scanner 1 comprises numerous elements of hardware and operational software. In accordance with FIG. 1A, a general overview of a scanner 1 apparatus and system comprising various elements of hardware is shown. More specifically, a scanner 1 system and structure for scanning a user 5 is provided comprising side lights 3, top lights 6, a plurality of voids 35 disposed in a plurality of vertical structures 2 to permit the placement accommodation of a plurality of multi-lens camera devices 70 (shown in FIG. 1D) positioned and adjusted as desired at differing angles to provide multiple angles of a user 5 when scanned by the scanner 1. The current embodiment of the scanner 1 incorporates a smart phone device having a multi-lens camera as the herein disclosed multi-lens camera device 70. It is apparent that any smart device having sufficient capability for processing and having a multi-lens camera can be utilized for the multi-lens camera device 70. Additionally, the scanner 1 system comprises a server 75 for providing a multiplicity of functions including, but not limited to, local storage capability.

FIG. 1B shows in further detail an exemplary portion of the plurality of vertical structures 2 further detailing the plurality of voids 35 disposed therein to permit the accommodation and removably adjustable mounting of the plurality of multi-lens camera devices 70 (as shown in FIG. 1D) positioned at differing angles to provide multiple angles of the user 5 when scanned by the scanner 1. In addition, FIG. 1B provides for a tablet smart device 4 for providing a plurality of functions including, but not limited to, countdown, sound queue and artificial intelligence (AI) pose detection as examples.

FIG. 1C provides for and depicts certain adjustment mechanisms to provide a range of multi-axis adjustments to the multi-lens camera devices 70 (individual adjustments are made per multi-lens camera device 70) including a horizontal axis adjustment device 40, a vertical axis adjustment device 45, and incorporating a light blocker device 50 to provide light control coming to the multi-lens camera device 45.

FIG. 1D details further how the multi-lens camera systems 70 is positioned and mounted in one of the voids 35 in one of the plurality of vertical structures 2. A portion of one of the vertical structures 2 having the void 35 is shown and provides for power and network connections 55 and capability, connectivity to image capture software 60, and an instruction holder 65.

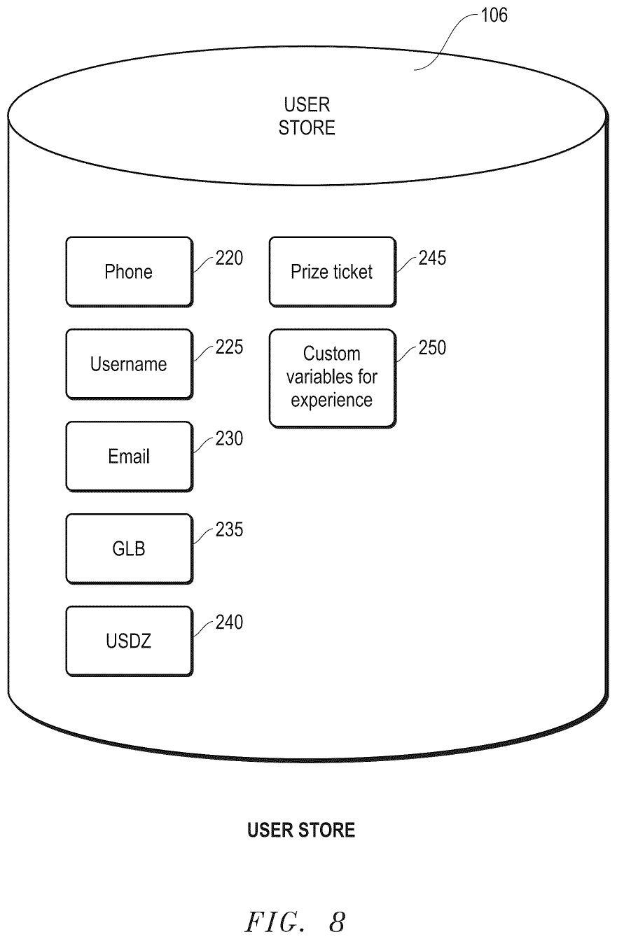

Now with reference to FIG. 1E, an overview of the present invention and steps for creation of an automated human mesh and skeleton generation by way of the scanner 1 apparatus (as shown in FIG. 1A) is provided. The steps as shown comprise user registration 101, user scan 102, model creation 103, shareable creation 104, shareable delivery 105 and a user store 106 (see also FIG. 8). The user store 106 as shown in detail in FIG. 8 is configured to store a phone number 220, a username 225, an email address 230, a glb file 235, a .usdz file 240, prize ticket information 245, and a plurality of custom variables for a overall user experience 250.

FIG. 1E depicts an overview of the scanner 1 operating steps. Specifically, the use registration 101 step, the user scan 102 step, the model creation 103 step, the shareable creation 104 step, the shareable delivery 105 step, and the user store 106 step.

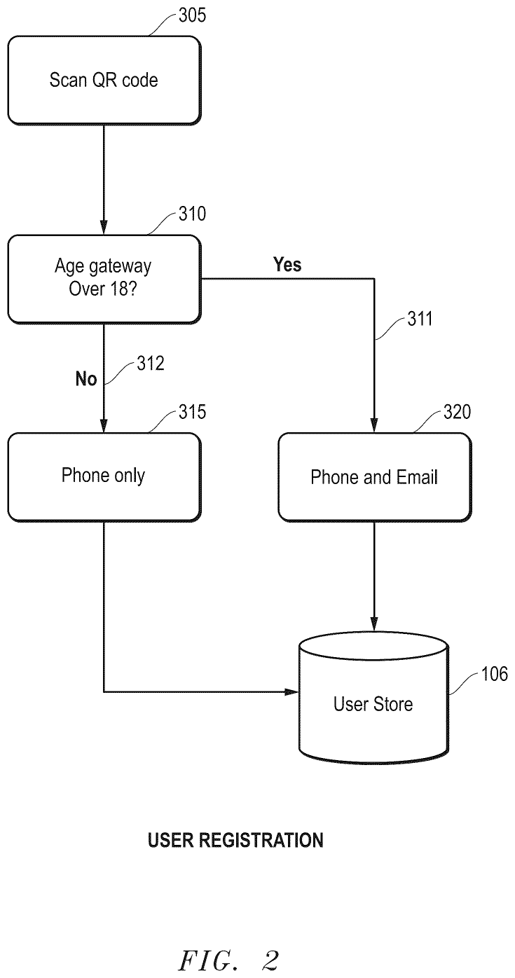

FIG. 2 shows a breakdown of the software step functions conducted within the user registration 101 step. The user registration 101 step shown in FIG. 1E and further depicted in FIG. 2 provides for the scanning of a QR code 305 and the user's 5 age is determined 310 for input and for the user 5 to input various registration data, wherein the user 5 (e.g., a human being) can register and provide the user's 5 phone number only if not over 312 the age of eighteen or phone number and email 320 if user's 5 age is over 311 eighteen. Upon completion of inserting such information in the user registration step 101 of FIG. 1E, all obtained and inputted data is loaded to the user store 106.

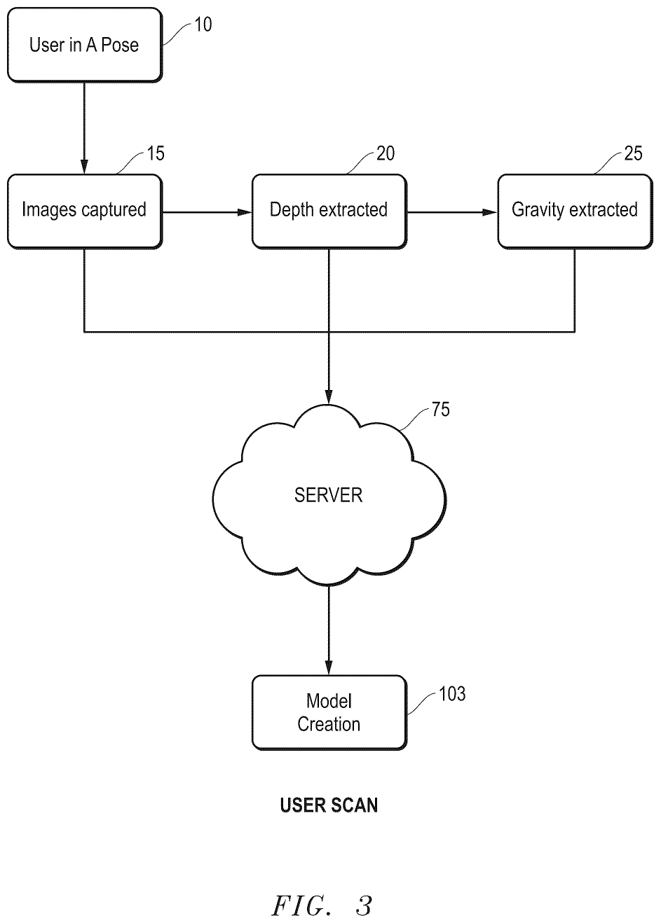

FIG. 3 depicts the steps within the user scan 102 step shown in FIG. 1E. In accordance with FIG. 2, the user scan 102 step comprises the user 5 verifying their user info with a brand ambassador and then the user 5 enters into the scanner 1 and stands in a desired pose in step 10, where after a 5 second countdown conducted by the tablet smart device 4 as discussed above, the user 5 is scanned by the scanner 1 where images are captured in step 15, depth is extracted in step 20, and gravity is extracted in step 25. Thereafter, all scanned and entered data is stored on the server 75 under the user's 5 ID within the system.

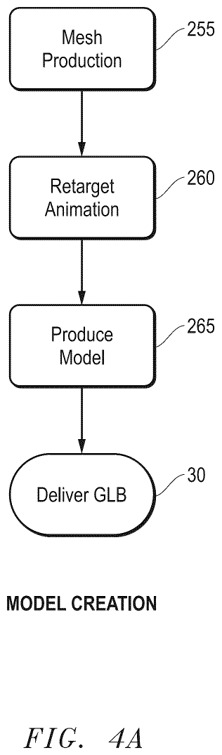

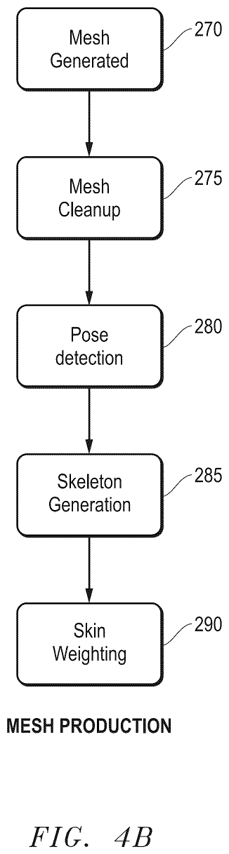

FIG. 4A provides for the overall steps of model creation step 103. FIG. 4A provides for the sub-steps, within the model creation step 103 as shown in FIG. 1E, and comprising mesh production 255, retarget animation 260, produce model 265, resulting in step 30 of delivering the .glb.

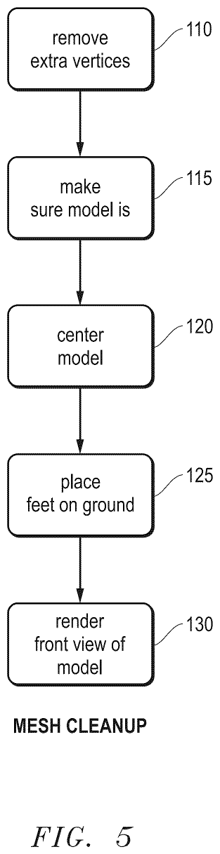

FIGS. 4B and 5 together provide for the steps of mesh production and mesh cleanup contained within the model creation 103 step shown in FIGS. 1A and 3. Accordingly, in FIG. 4B user data is analyzed and a mesh is generated in step 270 using photogrammetry. Thereafter, according to FIG. 4A mesh cleanup is conducted in step 275 of FIG. 4B after the mesh is generated so that only the user 5 subject remains. Any extraneous vertices are removed as shown in step 110 (see FIG. 5) until what remains is only the scanned user 5 in step 115 (see FIG. 5). A center of gravity is identified in step 120 (see FIG. 5) along with the feet so that a model of the user 5 can be placed with feet on the floor in step 125 (see FIG. 5) and the model centered and facing forward in step 130 (see FIG. 5).

Further in view of FIG. 4B, pose detection is conducted in step 280. The pose detection step 280 comprises a process that is run on the front facing render to determine the placement of bones and then skeleton generation in step 285 is conducted and is based on the placement of the bones such that a skeleton is then created and positioned in a geometry volume. Then, based on the relative location of the vertices to the bones of the skeleton, the vertices are skin weighted in step 290 to the skeleton.

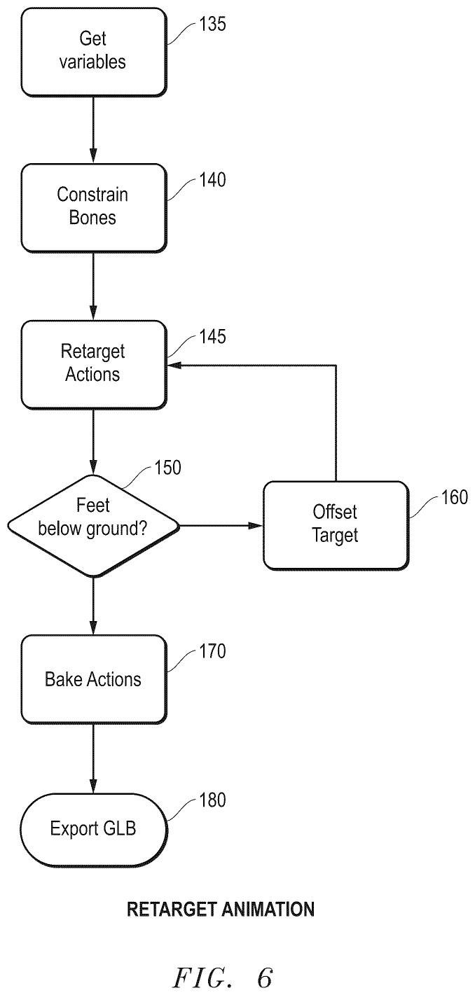

In reference now to FIG. 6, in step 135 any variables necessary for the shareable delivery are obtained and input into the retarget system. In step 140 each bone is constrained to the reference skeleton, and each animation action is retargeted to each bone in step 145. Next, in step 150 evaluation is made to determine if the feet are or are not below the ground. If the feet are below the ground, an offset to the animation is made in step 160 and then step 145 is re-accomplished. If then, the feet are not below the ground, all actions are baked to keyframes in step 170 in FIG. 6. Lastly, the model is then exported as a .glb file in step 180.

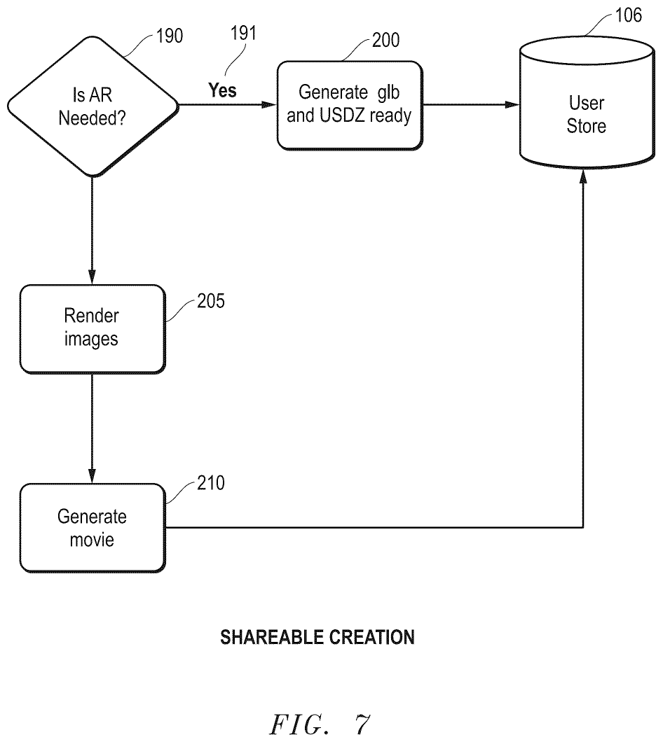

Next FIG. 7 provides step by step detail of step 104 shown in FIG. 1E for providing a shareable creation. The model that is produced in step 103 shown in FIG. 1E is retargeted with the animation data and a glb file or .usdz file for augmented reality (AR) use is generated. Images are rendered and a movie is generated. In FIG. 7, in step 190 a determination is made to determine if an augmented reality (AR) version of the model is needed 191. In the event that an augmented reality (AR) version is needed 191, then an AR version of the model in both .glb and .usdz formats are generated in step 200 and forwarded to the user store 106. Next, in step 205 images are rendered in an .mp4 format and then in step 210 rendered images are compiled into an .mp4 format and a movie is generated and passed on the use store 106.

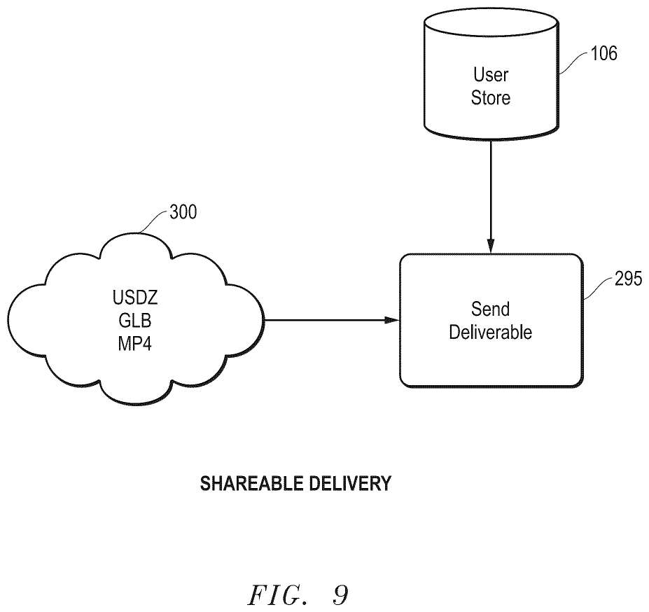

Finally in accordance with step 105 of FIG. 1E and with specific reference to FIG. 9, a shareable delivery is provided. The final glb and .usdz format files and generated .mp4 movie (collectively 300) are delivered by the requested delivery method of email or text message. Specifically, in step 295 of FIG. 9 using the user data collected and contained in the user store 106, the final deliverable is sent to the user 5 via the requested delivery service.

One skilled in the art will recognize that the hardware disclosed herein from which the present embodiment of the scanner is developed are not meant to be limiting and that other suitable materials can be used without departing from the spirit of the invention.

Embodiments as provided and disclosed above may be stated in general overall dimensions or in specifics so as to accommodate the specific scanner 1 desired for use. However, other embodiments contemplated by the inventor can have any dimension that also accomplishes the desired functions. Although the disclosed embodiments are illustrated as having certain general, absolute, and relative parts, components, and dimensions, those having skill in the art will recognize that the approximate or absolute and relative components and dimensions illustrated herein can be altered in accordance with varying design considerations. Other embodiments that do not have the same approximate or absolute and relative components and dimensions can be envisioned without departing from the scope of the invention and claims. Moreover, the disclosed embodiments are not necessarily illustrated to scale.

Without further elaboration, it is believed that one skilled in the art can, using the description herein, utilize the present disclosure to its fullest extent. The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A scanner apparatus for automating the generation and animation of a human mesh and skeleton, the apparatus comprising;
a plurality of vertical structures, wherein each of the vertical structures has a surface that defines a plurality of cavities in each of the vertical structures;
a plurality of multi-lens cameras adjustably mounted in each of the cavities, wherein the multi-lens cameras are configured having power and network communications ports;
a plurality of lights disposed on the plurality of vertical structures;
an image capture software in functional communication with the plurality of multi-lens cameras; and
a server in functional communication with the multi-lens cameras and the image capture software for providing multiple functions including local storage capability.

2. A method of providing a human mesh and skeleton, the method comprising assembling a scanner apparatus of claim 1 and executing steps to generate and animate a human mesh and skeleton, the method comprising the steps of:
registering a user;
scanning a user;
creating a model;
creating a shareable;
delivering a shareable; and
storing a user information.

3. The method as in claim 2, wherein the step of registering a user comprises scanning a QR code, determining the user's age, obtaining user registration data including the user's phone number only if not over the age of eighteen or phone number and email if user's age is over eighteen.

4. The method as in claim 2, wherein the step of scanning a user comprises verifying user information, the user physically entering into the scanner and standing in a desired pose and where after a countdown is conducted by a tablet smart device, scanning the user by capturing images, and extracting depth and gravity.

5. The method as in claim 2, wherein the step of creating a model comprises producing a mesh, providing for retarget animation, producing a model, and then delivering a .glb file.

6. The method as in claim 5, wherein the step of creating a shareable comprises using the model that is created and retargeting with the animation data and generating a .glb file or .usdz file for augmented reality, then rendering images and compiling into an .mp4 format, and then generating a movie, passing the movie on to a server for storage, and delivering the shareable.

7. The method as in claim 6, where in delivering the shareable comprises delivering the .glb and .usdz files and generated .mp4 movie by a requested delivery method of email or text message.

8. The method as in claim 2, wherein the step of storing a user information comprises storing a phone number, a username, an email address, a .glb file, a .usdz file, a prize ticket information, and a plurality of custom variables for an overall user experience.

9. A system for automating the generation and animation of a human mesh and skeleton, the system comprising:
a plurality of vertical structures, wherein each of the vertical structures has a surface that defines a plurality of cavities in each of the vertical structures;
a plurality of multi-lens cameras adjustably positioned in each of the cavities, wherein the multi-lens cameras are configured having power and network communications ports;
a plurality of lights disposed on the plurality of vertical structures;
an image capture software in connectivity with the multi-lens camera; and
a server in communication with the multi-lens cameras and the image software for providing a multiplicity of functions including local storage capability.

10. A method of providing a human mesh and skeleton, the method comprising assembling the system of claim 9 and executing steps to generate and animate a human mesh and skeleton, the method comprising the steps of:
registering a user;
scanning a user;
creating a model;
creating a shareable;
delivering a shareable; and
storing a user information.

11. The method as in claim 10, wherein the step of registering a user comprises scanning a QR code, determining the user's age, obtaining user registration data including the user's phone number only if not over the age of eighteen or phone number and email if user's age is over eighteen.

12. The method as in claim 10, wherein the step of scanning a user comprises verifying user information, the user physically entering into the scanner and standing in a desired pose and where after a countdown is conducted by a tablet smart device, scanning the user by capturing images, and extracting depth and gravity.

13. The method as in claim 10, wherein the step of creating a model comprises producing a mesh, providing for retarget animation, producing a model, and then delivering a .glb file.

14. The method as in claim 13, wherein the step of creating a shareable comprises using the model that is created and retargeting with the animation data and generating a .glb file or .usdz file for augmented reality, then rendering images and compiling into an .mp4 format, and then generating a movie, passing the movie on to a server for storage, and delivering the shareable.

15. The method as in claim 14, where in delivering the shareable comprises delivering the .glb and .usdz files and generated .mp4 movie by a requested delivery method of email or text message.

16. The method as in claim 10, wherein the step of storing a user information comprises storing a phone number, a username, an email address, a .glb file, a .usdz file, a prize ticket information, and a plurality of custom variables for an overall user experience.

17. A method of automating the generation and animation of a human mesh and skeleton with a scanner apparatus, the method comprising:
providing a scanner for automating the generation and animation of a human mesh and skeleton;
providing a plurality of multi-lens cameras;
providing an image capture software in communication with the plurality of multi-lens cameras; and
providing a server for providing scanner operational functions and for communication with the image capture software and the plurality of multi-lens cameras.

18. The method of claim 17, wherein the providing a scanner includes a scanner comprising a plurality of vertical structures with cavities to house the plurality of multi-lens cameras.

19. The method of claim 17, wherein the plurality of multi-lens cameras are functionally mounted in separate cavities wherein the mounting provides for separate and independent horizontal and vertical adjustments to each multi- lens camera.

20. The method of claim 18, wherein the providing the scanner includes providing a plurality of lights fixed to the scanner.
